(19) United States
(12) Patent Application Publication
(10) Pub. No.: US 2008/0079550 A1
(43) Pub. Date: Apr. 3, 2008

(54) APPARATUS AND METHOD FOR PROVIDING POWER TO A RADIO FREQUENCY IDENTIFICATION (RFID) TAG USING A MICROSTRUCTURE POWER DEVICE, SUCH AS A MICROELECTROMECHANICAL STRUCTURE (MEMS)-BASED POWER DEVICE

(75) Inventors: Templeton Briggs, Snohomish, WA (US); Michael Abel, Cedar Rapids, IA (US)

Correspondence Address: SEED INTELLECTUAL PROPERTY LAW GROUP PLLC, 701 FIFTH AVENUE, SUITE 5400, SEATTLE, WA, 98104-7092, US

(73) Assignee: Intermec IP Corp., Everett, WA (US)

(21) Appl. No.: 11/534,094

(22) Filed: Sep. 21, 2006

(51) Int. Cl. H04Q 5/22

(52) U.S. Cl. 340/10.34; 340/572.8; 340/693.1; 340/10.1

(57) ABSTRACT

A radio frequency identification (RFID) tag is powered by a microstructure power device. The microstructure power device can be a microelectromechanical structure (MEMS)-based device that derives power from energy harvested from mechanical vibrations. The RFID tag having the microstructure power device coupled thereto is affixed to an item and placed in an environment where mechanical vibrations are present. The mechanical vibrations provide sufficient power to allow the RFID tag to be read and/or written to by an automatic data collection device.

### TECHNICAL FIELD

This disclosure generally relates to the field of automatic data collection (ADC), for example, data acquisition via radio frequency identification (RFID) tags and readers. More particularly but not exclusively, the present disclosure relates to providing power to RFID tags.

### BACKGROUND INFORMATION

The ADC field includes a variety of different types of ADC data carriers and ADC readers operable to read data encoded in such data carriers. For example, data may be encoded in machine-readable symbols, such as barcode symbols, area or matrix code symbols, and/or stack code symbols. Machine-readable symbols readers may employ a scanner and/or imager to capture the data encoded in the optical pattern of such machine-readable symbols. Other types of data carriers and associated readers exist, for example magnetic stripes, optical memory tags, and touch memories.

Other types of ADC carriers include RFID tags that may store data in a wirelessly accessible memory, and may include a discrete power source (i.e., an active RFID tag), or may rely on power derived from an interrogation signal (i.e., a passive RFID tag). RFID readers typically emit a radio frequency (RF) interrogation signal that causes the RFID tag to respond with a return RF signal encoding the data stored in the memory.

Identification of an RFID device or tag generally depends on RF energy produced by a reader or interrogator arriving at the RFID tag and returning to the reader. Multiple protocols exist for use with RFID tags. These protocols may specify, among other things, particular frequency ranges, frequency channels, modulation schemes, security schemes, and data formats.

Many ADC systems that use RFID tags employ an RFID reader in communication with one or more host computing systems that act as central depositories to store and/or process and/or share data collected by the RFID reader. In many applications, wireless communications is provided between the RFID reader and the host computing system. Wireless communications allow the RFID reader to be mobile, may lower the cost associated with installation of an ADC system, and permit flexibility in reorganizing a facility, for example a warehouse.

RFID tags typically include a semiconductor device having the memory, circuitry, and one or more conductive traces that form an antenna. Typically, RFID tags act as transponders, providing information stored in the memory in response to the RF interrogation signal received at the antenna from the reader or other interrogator. Some RFID tags include security measures, such as passwords and/or encryption. Many RFID tags also permit information to be written or stored in the memory via an RF signal.

With active RFID tags, the discrete power source is often in the form of a battery. The use of the battery causes such active RFID tags to be disadvantageously large in size and expensive to manufacture and use. For instance, periodic maintenance or battery replacement may be required to ensure that an active RFID tag is sufficiently powered.

In comparison, passive RFID tags are generally smaller and less expensive than active RFID tags. Further, passive RFID tags are capable of being assembled into printable “smart labels.” However, it can be difficult to supply passive RFID tags with sufficient power. For example, the power that a passive RFID tag may acquire from an RF field of the interrogation signal is inversely proportionally to a distance between the RFID tag and the source of the interrogation signal.

Moreover, the antenna of a passive RFID tag has to be designed in such a manner that the antenna is capable of both acquisition of power from the RF field and transmission/reception of signals. Such requirements for antennas of passive RFID tags can result in more complicated antenna designs, thereby increasing the overall costs and complexity of passive RFID tags.

### BRIEF SUMMARY

One aspect provides an apparatus that includes a wireless data carrier that can be placed in an environment where mechanical vibrations are present. At least one microstructure power device is coupled to the wireless data carrier. The microstructure power device is adapted to harvest energy from the mechanical vibrations and to provide the harvested energy to the wireless data carrier. The wireless data carrier is adapted to apply the harvested energy provided by the microstructure power device to power operations, independently of and without using a discrete power source that provides power different from power derived from the energy harvested by the microstructure power device.

### BRIEF DESCRIPTION OF THE SEVERAL VIEWS OF THE DRAWINGS

Non-limiting and non-exhaustive embodiments are described with reference to the following drawings, wherein like reference numerals refer to like parts throughout the various views unless otherwise specified. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic block diagram of an example system to read an embodiment of an RFID tag that receives power from a microstructure power device.

FIG. 2 is a schematic block diagram of another example system to read an embodiment of an RFID tag that receives power from an array of microstructure power devices.

FIG. 3 illustrates application of mechanical vibrations to an RFID tag having one or more microstructure power devices according to one embodiment.

FIG. 4 is a top view on one embodiment of the microstructure power devices of FIGS. 1-3.

FIG. 5 is a side cross-sectional view of the embodiment of the microstructure power device of FIG. 4.

FIG. 6 is a side view showing in greater detail a portion of the microstructure power device of FIGS. 4-5 that uses an electrostatic (capacitive) energy harvesting technique to harvest energy from mechanical vibrations according to an embodiment.

FIG. 7 is a block diagram showing storage and application of the energy harvested by the microstructure power device according to one embodiment.

FIG. 8 is a side view of a portion of one embodiment of the microstructure power device that uses a piezoelectric energy harvesting technique to harvest energy from mechanical vibrations according to an embodiment.

FIG. 9 is a side view of a portion of one embodiment of the microstructure power device that uses an electromagnetic energy harvesting technique to harvest energy from mechanical vibrations according to an embodiment.

FIG. 10 is a flow diagram of an embodiment of a method to provide power to an RFID tag using a microstructure power device.

### DETAILED DESCRIPTION

Embodiments of techniques to provide power to an RFID tag using a microstructure power device are described herein. In the following description, numerous specific details are given to provide a thorough understanding of embodiments. One skilled in the relevant art will recognize, however, that the embodiments can be practiced without one or more of the specific details, or with other methods, components, materials, etc. In other instances, well-known structures, materials, or operations associated with RFID tags and RFID readers, computer and/or telecommunications networks, and/or computing systems are not shown or described in detail to avoid obscuring aspects of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

As an overview, one embodiment provides power to wireless data carrier, such as an RFID tag, using a microstructure power device that is capable of supplying microwatts of power, for example. The microstructure power device of one embodiment is a microelectromechanical system (MEMS)-based device that operates to harvest energy from mechanical vibrations. Embodiments of the RFID tag powered by the microstructure power device can further provide energy storage capabilities in which the energy harvested from mechanical vibrations is stored and subsequently applied for use in reading, writing, and/or other operations.

According to one embodiment, the microstructure power device uses electrostatic energy harvesting techniques in which the capacitance of a capacitor is varied by mechanical vibrations. In another embodiment, the microstructure power device can use piezoelectric energy harvesting techniques in which mechanical energy from mechanical vibrations is used to strain a piezoelectric material. In yet another embodiment, the microstructure power device can use electromagnetic energy harvesting techniques in which a magnetic field converts mechanical energy from mechanical vibrations to electrical energy.

According to one embodiment, the RFID tag can be read (and/or written to) while the RFID tag is in motion, such as when a product onto which the RFID tag is affixed is placed on a conveyor belt, forklift, or other machinery. Such machinery produces mechanical vibrational energy that can be harvested by the microstructure power device and then used to power the RFID tag for reading/writing operations. The RFID tag can also be read (and/or written to) after motion from the machinery has ended if the RFID tag has been provided with an energy storage device that has stored the previously harvested energy from the mechanical vibrations. Alternatively or additionally, ambient mechanical vibrational energy from buildings or other environments may also be sufficient to provide power to the RFID tag for reading/writing operations, even if the RFID tag is not physically present on moving machinery (e.g., the product having the RFID tag affixed thereto may be sitting on a storage shelf). Thus, the RFID tag can be provided with capability to harvest energy (and thus be read or written to) during many different situations and environments when mechanical vibrational energy is present.

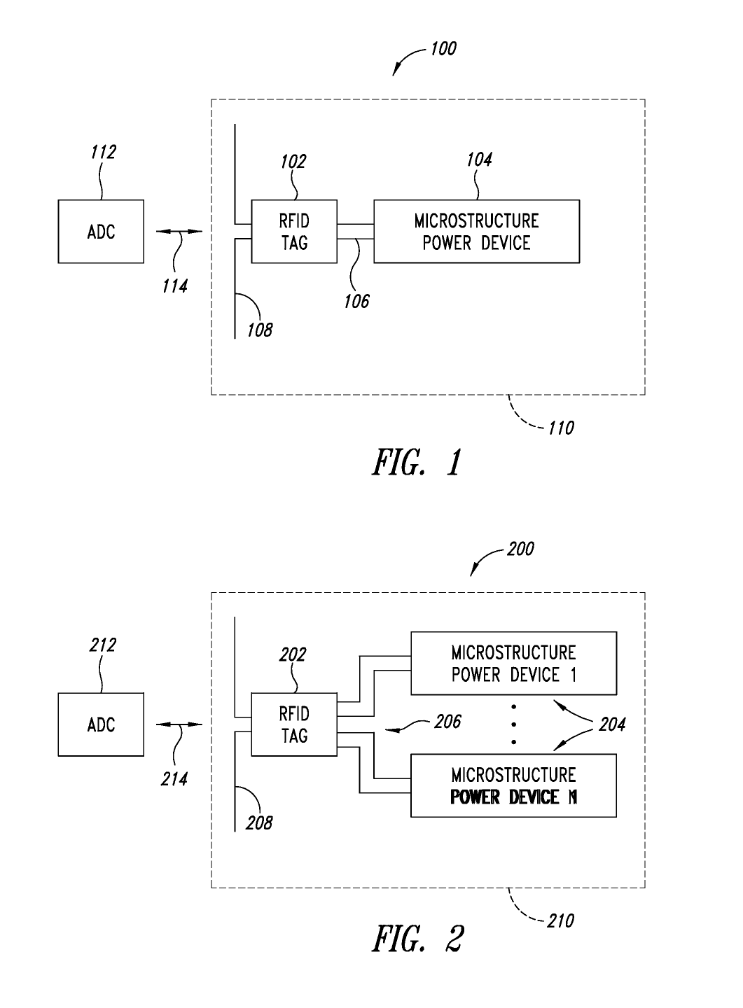

Referring first to FIG. 1, shown generally at 100 is an embodiment of a system to read (and/or to write to) an RFID tag 102 that is powered by a microstructure power device 104. The microstructure power device 104 operates to harvest energy from mechanical vibrations, in a manner that will be described in further detail below. The RFID tag 102 is coupled to the microstructure power device 104 via conductors 106 that carry the power derived from the harvested energy to the RFID tag 102.

The RFID tag 102 typically acts as a transponder, transmitting responses (to an interrogation signal) that encode information or data stored in memories of the RFID tag 102. Some of the RFID tags 102 may also be written to, and may employ security measures and/or encryption techniques. The structure and method of operation of the RFID tag 102, as well as RFID interrogators and other RFID readers are well known in the art and need not be discussed in great detail hereinafter.

The RFID tag 102 includes or is otherwise coupled to an RF antenna 108. According to an embodiment, since the microstructure power device 104 has been provided for energy harvesting, the RFID tag 102 need not implement the complex antenna design of conventional passive RFID tags that need to perform the multiple tasks of signal reception/transmission plus acquisition of power from an RF field. Instead, the antenna 108 of one embodiment can be designed solely for transmission and reception of RF signals for data communication.

Such an embodiment of the antenna 108 can be simpler in design (such as a dipole antenna), thereby providing cost reduction benefits. Furthermore, an embodiment of the antenna 108 that is designed primarily for signal transmission/reception (and not further designed for RF power acquisition) would have increased range and performance, reduce the overall size of the RFID tag 102, and improve omnidirectional performance.

Moreover, RFID tags having conventional antennas that are designed for the multiple purposes of signal transmission/reception and RF power acquisition may be more sensitive to physical impacts on the RFID tag, such as impacts against the RFID tag during shipping and handling. Minor damage to such conventional antennas may reduce or completely remove the RF power acquisition capability of the RFID tag, thereby making the RFID tag useless, even if the damage itself does not significantly affect or otherwise damage the signal transmission/reception capability of the antenna. In contrast, the RFID tag 102 of one embodiment may continue to function adequately even if minor damage to the antenna 108 occurs, since the antenna 108 is not being relied upon to provide power to the RFID tag 102.

In another embodiment, the antenna 108 can be designed for signal transmission/reception plus power acquisition from an RF field. In such an embodiment, the power derived from the energy harvested by the microstructure power device 104 can be used to increase and/or enhance range and performance of the RFID tag 102.

The RFID tag 102, the microstructure power device 104, and the related structures shown in FIG. 1 can be present on a substrate 110. The substrate 110 can comprise a semiconductor substrate 110 of an integrated circuit (IC) in one embodiment where the RFID tag 102, the microstructure power 104, and the related structures shown in FIG. 1 are physically present on a same chip.

In another embodiment, the RFID tag 102 and the microstructure power device 104 can comprise different or discrete ICs, chips, or other assemblies. In such an embodiment, the substrate 110 of FIG. 1 can represent the packaging for such assemblies, such as a “label” having the assemblies present therein and coupled to each other.

The system 100 includes an automatic data collection device 112 to read from or write to the RFID tag 102 using one or more wireless signals 114. The automatic data collection device 112 of one embodiment comprises a handheld device. The automatic data collection device 112 of another embodiment can comprise a stationary device, such as a fixed device that interrogates RFID tags 102 affixed to items moving on a conveyor belt.

FIG. 2 at 200 shows another embodiment of a system to read (and/or to write to) an RFID tag 202. The system 200 of FIG. 2 is similar to the system 100 of FIG. 1 in that the system 200 includes an antenna 208, a substrate 210, and an automatic data collection device 212 that are all similar in features to the corresponding embodiments described above with reference to FIG. 1.

However, with the embodiment of the system 200 in FIG. 2, the RFID tag 202 can be powered by a plurality of microstructure power devices 204. The microstructure power devices 204 are respectively coupled to the RFID tag 202 by corresponding conductors 206. The microstructure power devices 204 are arranged in an array of N microstructure power devices 204, so as to provide more power to the RFID tag 202 as compared to just a single microstructure power device 204.

The number N of microstructure power devices 204 in the embodiment of FIG. 2 can range from a minimum of N=2 to some other higher number, depending on factors such as the available real estate on the substrate 210, the power requirements for the RFID tag 202, manufacturing and costs considerations, and other factors. In one embodiment all of the microstructure power devices 204 use a same technique for energy harvesting (such as electrostatic energy harvesting), while in another embodiment, individual ones of the microstructure power devices 204 may use different energy harvesting techniques (such as electrostatic, piezoelectric, or electromagnetic energy harvesting) relative to other microstructure power devices 204 on the same substrate 210.

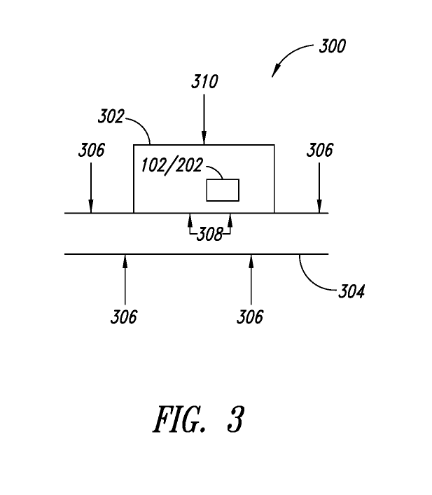

FIG. 3 shows an example environment 300 in which the RFID tag 102/202 can be provided with power derived from harvested mechanical vibrational energy. The RFID tag 102/202 in FIG. 3 is affixed to an item 302, which can comprise a product, packaging for a product, a box or other container containing multiple products, etc. The item 302 is placed on a platform 304.

The platform 304 can comprise a conveyor belt, forklift, inventory shelf, vehicle cargo hold, pallet board, shipping container, or other structure onto or into which items 302 are typically placed. In the case of a conveyor belt, forklift, vehicle cargo hold, or other types of platforms associated with machinery, such machinery produces mechanical vibrations (e.g., actively induced vibrations or pressure waves such as those commonly denoted as sound) that are transferred onto the platform 304, as symbolically shown at 306 in FIG. 3. Such mechanical vibrations 306 are then transferred from the platform to the item 302, as symbolically shown at 308 in FIG. 3. The mechanical vibrations 308 then ultimately propagate to the vicinity of the RFID tag 102/202. In some situations, mechanical vibrations may be applied directly to the item 302 and/or to the vicinity of the RFID tag 102/202 without having to propagate through the platform 304, such as symbolically shown at 310. In an embodiment, the microstructure power devices 104/204 can harvest the energy from such mechanical vibrations 306-310 caused by machinery.

The mechanical vibrations 306-310 of FIG. 3 can alternatively or additionally represent ambient mechanical vibration. For example, if the RFID tag 102/202 is resting on an inventory shelf in a building, ambient mechanical vibrations 306-310 may also be present. Such ambient mechanical vibrations can be caused by factors including but not limited to persons walking in the building, circulating air in the building, settling of the building, seismological movement, changing air pressure and other weather conditions, elevator and door movements propagating through the building, and so forth. In an embodiment, the microstructure power devices 104/204 can harvest the energy from such ambient mechanical vibrations 306-310.

With the environment 300 depicted in FIG. 3, an unpowered RFID tag 102/202 can thus be placed into a powered state when mechanical vibrations 306-310 are present and from which energy can be harvested. The RFID tag 102/202 can then be read/written to after being sufficiently powered. Alternatively or additionally, the RFID tag 102/202 can be provided with energy storage capability, such that the harvested energy can be accumulated over time for future reading/writing, and further, the harvested energy can be resupplied as needed if the stored energy is depleted over time and if the mechanical vibrations 306-310 remain available for energy harvest.

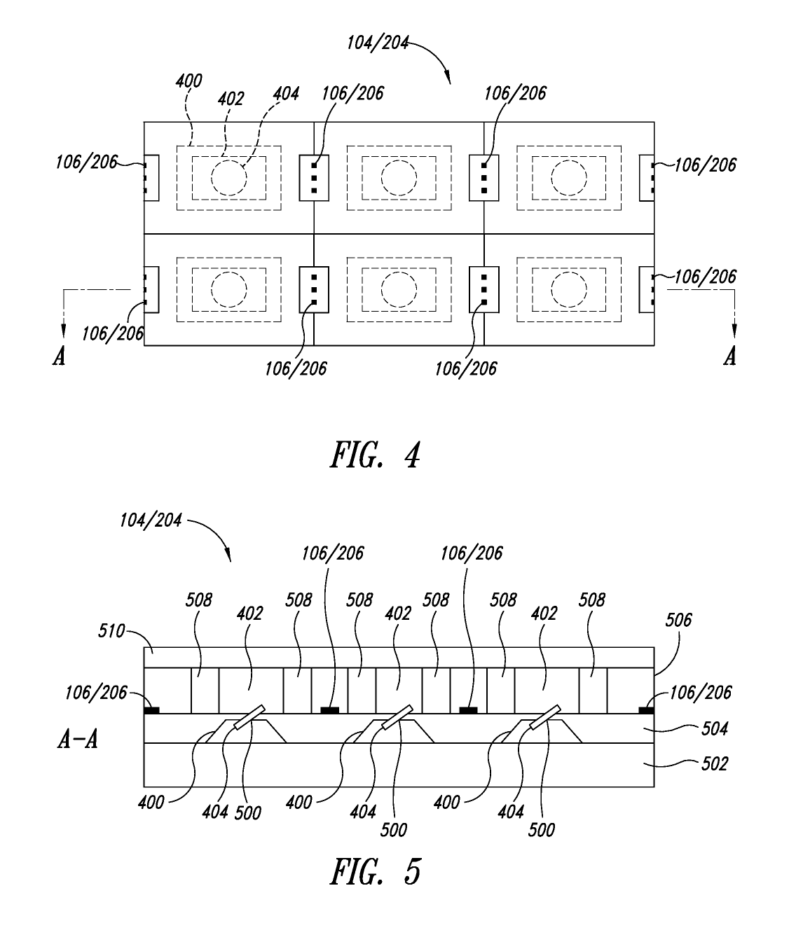

FIGS. 4-5 show one possible embodiment of the microstructure power device 102/204. The microstructure power device 104/204 of one embodiment can be manufactured using microelectromechanical system (MEMS) technology, such that the microstructure power device 104/204 is of sufficiently small size to be placed on a label or other product having the RFID tag 102/202.

The microstructure power device 102/202 comprises at least one base element 400 positioned in proximity to a cavity 402. The base element 400 has at least one movable element 404 mounted thereon that is adapted to move within the cavity 402 in response to mechanical vibrations. The base element 400, cavity 402, movable element 404, and other features of the microstructure power device 102/204 are shown in further detail in FIG. 5. The conductors 106 are coupled to the microstructure power device 102/204 via pads, traces, or other suitable conductive element on the microstructure power device 102/204.

For purposes of explanation, a plurality of six (6) movable elements 404 (and their associated base elements 400 and cavities 402) are shown in FIGS. 4-5 as being arranged in an array, and it is appreciated that a fewer or a greater number of movable elements 404 (and their associated base elements 400 and cavities 402) can be provided in other embodiments. For instance, the number of movable elements 404 might be increased in number if a greater power output is desired and/or there is sufficient available area or “real estate” in the microstructure power device 102/204. Moreover, the size and/or shapes of the movable elements 404 can be different from one embodiment to another. For the sake of illustration, FIGS. 4-5 depict an embodiment where the movable elements 404 are generally circular in shape.

With specific reference now to FIG. 5, each movable element 404 is coupled to their respective base element 400 by a torsional spring 500 that operates as a pivot point. The torsional spring 500 has sufficient strength to support the movable element 404, and has sufficient flexibility to further allow the movable element 404 to move within the cavity 402 in response to mechanical vibration. For example, FIG. 5 shows a first extreme position of the movable elements 404, wherein right ends of the movable elements 404 are positioned upwards and left ends of the movable elements 404 are positioned downward. The second extreme position of the movable elements 404 is the reverse, such that during movement in response to mechanical vibrations, the movable elements 404 move like a “teeter totter” or “see saw” within the cavities 402.

It is appreciated that the movable elements 404 need not necessarily have synchronized and equal-magnitude movement. For instance, some movable elements 404 may have their right ends in the upward position, while other movable elements 404 have their right ends in the downward position, while still other movable elements 404 have positions in between these two extreme positions. As another example, some movable elements 404 may experience a greater magnitude and/or frequency of movement during a period of time in response to mechanical vibrations, as compared to other movable elements 404 in the same microstructure power device 102/204.

In an embodiment, the microstructure power device 102/204 includes an unpatterned silicon backside wafer 502 on which the base elements 400 are formed. In an embodiment, the base elements 400, the movable elements 404, and the torsional springs 500 are made from a silicon material present in a layer 504, such as a MEMS wafer.

A layer 506, such as patterned silicon topside wafer, is located above the layer 504. The layer 506 includes the cavities 402, which are defined by silicon structures 508. In an embodiment, the silicon structures 508 can be manufactured using deposition and/or etching techniques, and further, air or other suitable gas can be present in the cavities 402. Portions of the conductors 106 (such as conductive pads or traces) can also be present in the layer 506.

A patterned (or unpatterned) seal 510 overlies the layer 506. The seal 510 protects the underlying components from dust, corrosion, scratching, or other physical and/or environmental effects that can cause damage. An example material for the seal 510 is glass, and other types of material (such as plastic) can be used.

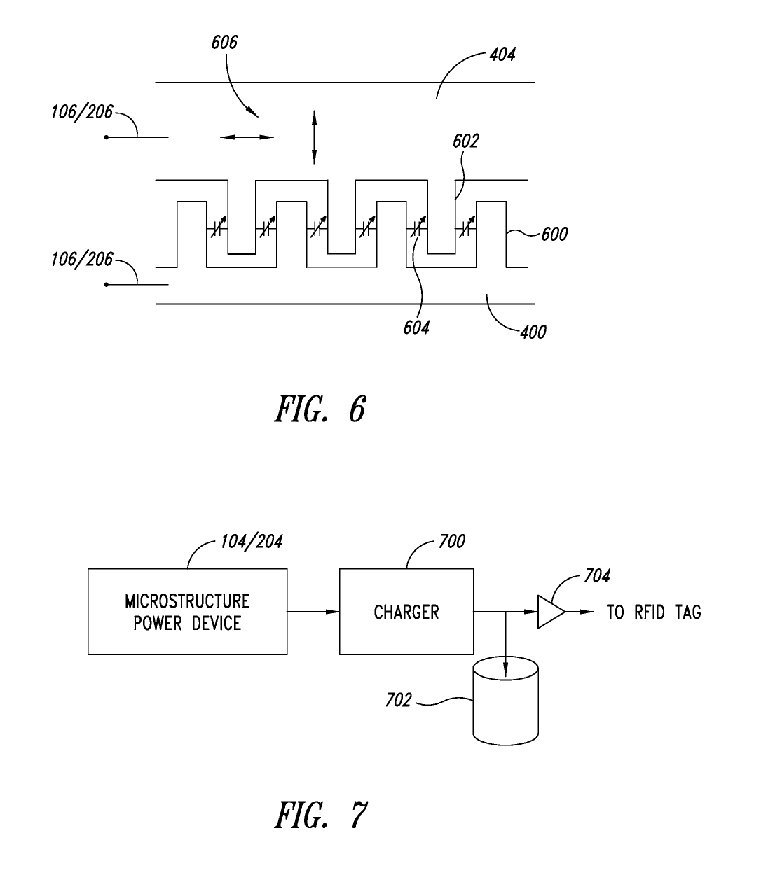

An embodiment of the microstructure power device 102/204 is based on electrostatic (capacitive) energy harvesting, which relies on the changing capacitance of vibration-dependent variable capacitors. As depicted in FIG. 6, portions (such as upper surface portions) of each base element 400 include a plurality of spaced-apart and upward facing structures, which are shown as having generally rectangular shapes in FIG. 6. Portions (such as end portions) of each movable element 404 include a plurality of spaced-apart and downward facing structures 602, which are also shown as having generally rectangular shapes in FIG. 6. Shapes of the structures 600 and 602 different from rectangles may be used in other embodiments.

The structures 602 interleave with the structures 600 such that variable capacitances 604 exist between opposing surfaces of the structures 600 and 602, which form capacitor plates. In operation, the structures 600 and 602 are initially charged, thereby initially charging the capacitor plates. Mechanical vibrations then cause the structures 602 to undergo motion (symbolically depicted by the arrows 606). As the structure 602 changes positions due to mechanical vibrations, the capacitor plates separate (thereby varying the capacitances 604) and mechanical energy is transformed into electrical energy.

In one embodiment, the structures 602 and 604 can be fabricated as MEMS variable capacitors through relatively mature silicon micro-machining techniques. This electrostatic (capacitive) energy harvesting technique described above produces higher and more practical output voltage levels than electromagnetic techniques for energy harvesting, and further provides moderate power density.

As shown in FIG. 6, the conductors 106 are electrically coupled to the capacitor plates to transfer the harvested energy to the RFID tag 102/202. The conductors 106 in one embodiment can comprises conductive traces, wires, or other conductive material that electrically couples the capacitor plates to the RFID tag 102/202.

In one embodiment, the energy harvested using the microstructure power device 104/204 of FIGS. 5-6 comprises intermittent bursts of energy that are available when mechanical vibration is present. Such situations can occur, for example, during periods of time when the item 302 of FIG. 3 is in motion on a conveyor belt or forklift and/or when ambient mechanical vibration is present. In these periods of time (which can be relatively short), the automatic data collection device 112/212 may be used to read from and/or write to the RFID tag 102/202. The intermittent bursts of harvested energy can be sufficient to perform such operations.

In one embodiment, the harvested energy can also be used to enhance range and performance of the RFID tag 102/202. For instance, if the antenna 108/208 is a “hybrid” design that is capable of power acquisition from an RF field and signal transmission/reception, the harvested energy from the microstructure power device 104/204 can be used as auxiliary power to enhance the range of signal transmission/reception or for other purposes and operations that involve power consumption.

In another embodiment, such as shown in FIG. 7, at least some of the harvested energy can be stored for later use. For example, there may be situations where the intermittent bursts of harvested energy may be insufficient to read from or write to the RFID tag 102/202. Accordingly, such energy can be stored or otherwise accumulated until a sufficient amount is available to perform reading, writing, or other operations. The stored energy can also be used for situations when the RFID tag 102/202 is in an environment where mechanical vibrations are minimal or nonexistent, but data needs to be read from or written to the RFID tag 102/202. Thus, the harvested and stored energy can be used to perform reading, writing, or other operations in such situations.

In the embodiment of FIG. 7, a charger circuit 700 is coupled to the microstructure power device 104/204 to receive the harvested energy. The charger circuit 700 then transfers the harvested energy to an energy storage unit 702 coupled thereto. In one embodiment, the energy storage unit 702 comprises a rechargeable thin-film lithium-ion battery that is compatible with smaller integrated circuit (IC) designs. A voltage regulator 704 is coupled to the energy storage unit 702 and to the charger circuit 700 to control the delivery of power to the RFID tag 102/202.

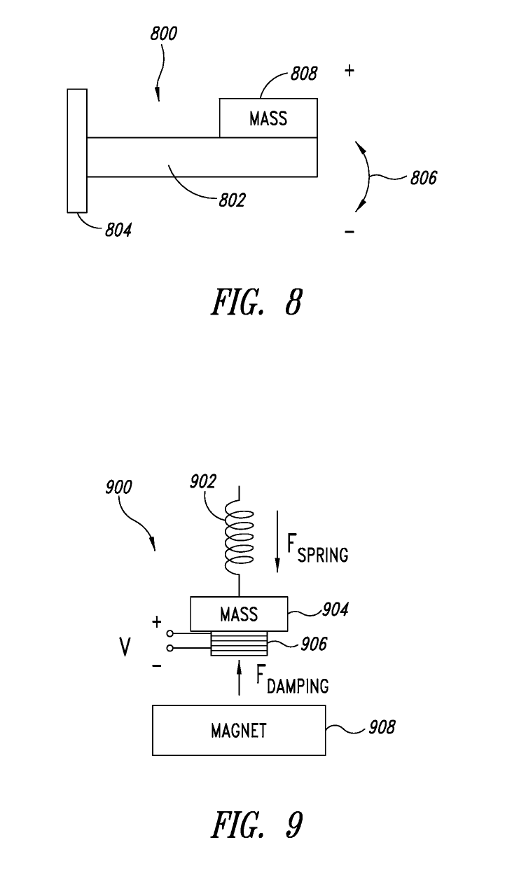

The various embodiments described above implement electrostatic (capacitive) energy harvesting techniques for the microstructure power device 104/204. It is appreciated that other types of energy harvesting techniques may be used in other embodiments to obtain energy from mechanical vibrations. FIGS. 8 and 9 show examples of such embodiments.

In FIG. 8, an embodiment of a piezoelectric assembly 800 uses a piezoelectric energy harvesting technique in which mechanical energy is converted into electrical energy by straining a piezoelectric material 802. Strain or deformation in the piezoelectric material 802 along an arrow 806 causes a charge separation across the assembly 800. The charge separation produces an electric field and thus a voltage drop proportional to the strain applied to the piezoelectric material 802.

In one embodiment, the piezoelectric material 802 comprises a cantilevered beam structure having at least one mass 808 at a distal end of the beam structure. A support structure 804 is provided at a proximate end of the beam structure. When mechanical vibration is present, the mass 808 and the piezoelectric material 802 move in a motion depicted by the arrow 806.

Example piezoelectric energy harvesting techniques and structures that can be implemented in various embodiments are disclosed in Tanielian (U.S. Pat. No. 6,771,007), Oliver (U.S. Pat. No. 6,407,484), Kimura (U.S. Pat. No. 5,801,475), and Tuttle (U.S. Pat. No. 5,300,875). These patents are incorporated herein by reference in their entireties.

In FIG. 9, an embodiment of an electromagnetic assembly 900 uses an electromagnetic energy harvesting technique in which a magnetic field is used to covert mechanical energy to electrical energy. A spring 902 is attached to a mass 904, and the mass 904 oscillates with the contraction and expansion (depicted as forces F_{DAMPING} and F_{SPRING} in FIG. 9) of the spring 902 in response to mechanical vibrations.

A coil 906 is attached to the oscillating mass 904 and traverses through a magnetic field that is provided by a magnet 908. The coil 906 thus travels through a varying amount of magnetic flux, thereby inducing a voltage V according to Faraday's Law.

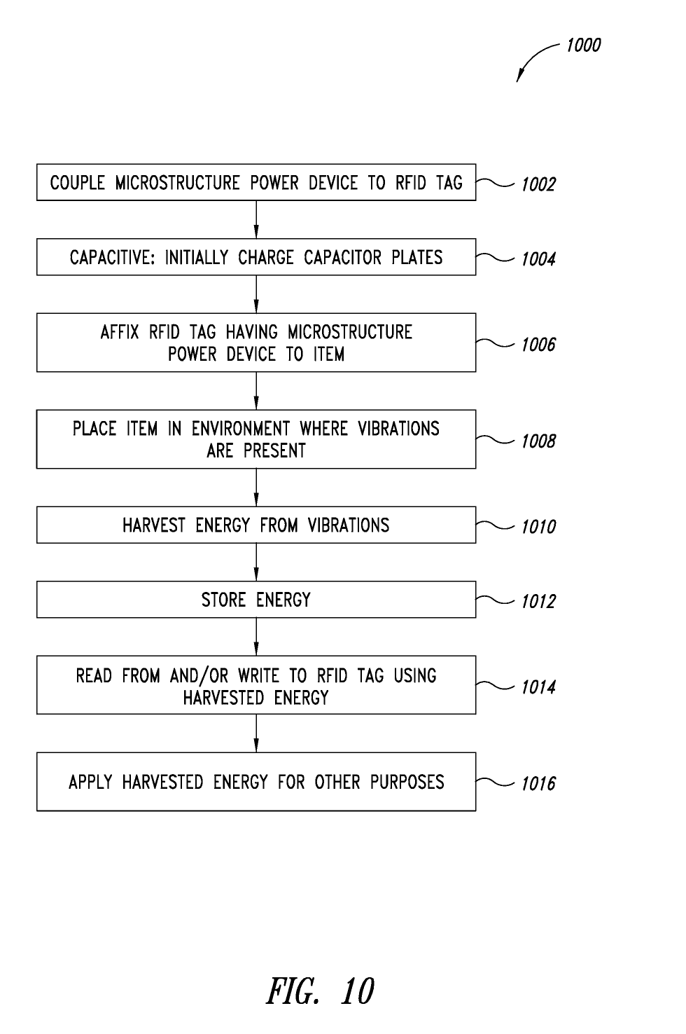

FIG. 10 is a flowchart of an embodiment of a method 1000 to provide power to an RFID tag (such as the RFID tag 102/202), using the microstructure power device 104/204. It is appreciated that the various operations in the flowchart of FIG. 10 need not necessarily occur in the exact order shown. Moreover, certain operations can be added, removed, modified, or combined.

In some embodiments, certain operations of the method 1000 can be implemented in software or other machine-readable instruction stored on a machine-readable medium and executable by a processor. For example, application of the harvested energy for reading, writing, or other operations of the RFID tag 102/202 or the automatic data collection device 112/212 can be performed using software.

At a block 1002, the microstructure power device 104/204 is coupled to the RFID tag 102/202. In one embodiment, the operations at the block 1002 are performed during the manufacturing stage by: manufacturing the embodiments of the microstructure power device 104/204 and components thereof shown in FIGS. 4-9 (for example); placing one or more of the microstructure power devices 104/204 on a same label, IC, or other substrate along with the RFID tag 102/202; and electrically coupling the one or more microstructure power device 104/204 to the RFID tag 102/202. In an embodiment of the microstructure power device 104/204 that uses electrostatic (capacitive) energy harvesting techniques, the capacitor plates formed by the structures 600 and 602 may be initially charged at a block 1004.

At a block 1006, the RFID tag 102/202 having the microstructure power device(s) 104/204 coupled thereto is affixed to the item 302 of FIG. 3. The item 302 having the RFID tag 102/202 affixed thereto is placed in an environment where mechanical vibration is present at a block 1008.

In a block 1010, the microstructure power device 104/204 harvests energy from mechanical vibrations. Accordingly, the RFID tag 102/202 inherently becomes “activated”, substantially without requiring a discrete power source (such as a battery) as a source for power different from the power derived from mechanical vibrations and/or without obtaining energy from an RF field. The RFID tag 102/202 is thus autonomous and capable of indefinite “active” operation independently of a discrete power source (and therefore not requiring battery maintenance).

In some embodiments, energy storage capabilities and operations may be provided at a block 1012. For example and with reference to FIG. 7, a charger circuit 700, energy storage unit 702, and other circuitry can be provided to accumulate the harvested energy and then apply the harvested energy for certain operation.

In other embodiments, reading from and/or writing to the RFID tag 102/202 using the harvested energy at a block 1014 can be performed substantially contemporaneously with the energy harvesting. Thus, as the energy is harvested, such harvested energy is immediately put to use to provide power for reading/writing and related operations.

At a block 1016, the harvested energy may be applied for other purpose, alternatively or additionally to the reading and writing operations at the block 1014. For example, in embodiments where the RFID tag 102/202 is a passive RFID tag that obtains power from an RF field, the harvested energy can be used to enhance the range and/or other capabilities of such an RFID tag by providing a power boost or other auxiliary power to supplement the power obtained through the RF field. In some embodiments, the energy harvested from mechanical vibrations can be used for other purposes, such as encryption, updating stored data, and so forth.

From the above description of embodiments, the MEMS-based or other type of microstructure power device 104/204 is capable of providing power to the RFID tag 102/202, thereby providing an alternative to passive RFID tags that rely on power obtained from an RF field. Relatively low cost, higher performance, and smaller-sized RFID tags 102/202 are thus possible, since the requirements for providing, maintaining, and replacing a discrete battery (of an active RFID tag) and the requirements for the complex multiple purpose antenna design (of a passive RFID tag) are eliminated.

The smaller size of the RFID tag 102/202 can further allow individual products (such as consumer products) to be tagged, rather being constrained to being applied to case-level or container level tagging. As a result, more detailed tracking and identification of individual products are possible.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

These and other modifications can be made to the embodiments in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a wireless data carrier that can be placed in an environment where mechanical vibrations are present; and
at least one microstructure power device coupled to the wireless data carrier, the microstructure power device being adapted to harvest energy from the mechanical vibrations and to provide the harvested energy to the wireless data carrier, the wireless data carrier being adapted to apply the harvested energy provided by the microstructure power device to power operations, independently of and without using a discrete power source that provides power different from power derived from the energy harvested by the microstructure power device.

2. The apparatus of claim 1 wherein the wireless data carrier comprises a radio frequency identification (RFID) tag.

3. The apparatus of claim 1 wherein the microstructure power device is adapted to use an electrostatic energy harvesting technique to harvest the energy from the mechanical vibrations.

4. The apparatus of claim 3 wherein the microstructure power device includes a plurality of structures that can interleave with one another to provide variable capacitances, the capacitances being made variable due to changes in separation between the interleaved structures in response to the mechanical vibrations.

5. The apparatus of claim 1 wherein the wireless data carrier includes an antenna to send signals to or from the wireless data carrier, the antenna being designed primarily for transmission and reception of said signals rather than power acquisition from a radio frequency field.

6. The apparatus of claim 1 wherein the wireless data carrier includes an antenna to send signals to or from the wireless data carrier, the antenna being designed for transmission and reception of said signals and further for power acquisition from a radio frequency (RF) field to power said operations, the power derived from the harvested energy being usable as auxiliary power to supplement the power acquired from the RF field or to power other operations.

7. The apparatus of claim 1 wherein the microstructure power device is adapted to use an electromagnetic energy harvesting technique to harvest the energy from the mechanical vibrations.

8. The apparatus of claim 1 wherein the microstructure power device is adapted to use piezoelectric energy harvesting technique to harvest the energy from the mechanical vibrations.

9. The apparatus of claim 1, further comprising additional ones of said microstructure power device arranged coupled to said wireless data carrier to collectively provide their harvested energy to the wireless data carrier.

10. The apparatus of claim 1, further comprising:
a charger circuit coupled to the microstructure power device to receive the energy harvested by the microstructure power device;
an energy storage unit coupled to the charger circuit to store the energy received by the charger circuit; and
a voltage regulator coupled to the charger circuit and to the energy storage unit to control delivery of the harvested to the wireless data carrier.

11. The apparatus of claim 1 wherein the mechanical vibrations include ambient mechanical vibrations.

12. The apparatus of claim 1 wherein the mechanical vibrations includes actively induced vibrations.

13. An apparatus, comprising:
an RFID tag that can be affixed to an item and that can be placed in an environment where mechanical vibrations are present;
at least one microstructure power device coupled to the RFID tag and adapted to harvest energy from the mechanical vibrations and to provide the harvested energy to power the RFID tag; and
an antenna coupled to the RFID tag to send and receive signals, the antenna being adapted primarily for communication of said signals or being adapted for both said communication and power acquisition to power the RFID tag additionally to said harvested energy.

14. The apparatus of claim 13 wherein the microstructure power device is a microelectromechanical structure (MEMS)-based device adapted to use electrostatic energy harvesting based on interleaving capacitive structures in the MEMS-based device, said structures having a separation therebetween that varies in response to the mechanical vibrations.

15. The apparatus of claim 13, further comprising additional ones of said microstructure power device coupled to the RFID tag to collectively provide their harvested energy to the RFID tag.

16. The apparatus of claim 13 wherein the harvested energy to power the RFID tag is provided independently and without use of a discrete power source that would otherwise provide energy different from said harvested energy from the mechanical vibrations.

17. A system to communicate with one or more wireless data carriers, the system comprising:
an automatic data collection device;
a wireless data carrier that can be affixed to an item and that can be placed in an environment where mechanical vibrations are present;
at least one microstructure power device electrically coupled to the wireless data carrier and adapted to harvest energy from the mechanical vibrations and to provide the harvested energy to power the wireless data carrier;
a substrate on which the wireless data carrier and microstructure power device are located; and
an antenna coupled to the wireless data carrier to communicate signals with the automatic data collection device, the antenna being adapted primarily for communication of said signals or being adapted for both said communication and power acquisition to power the wireless data carrier additionally to said harvested energy.

18. The system of claim 17 wherein the wireless data carrier includes an RFID tag and the automatic data collection device includes a hand-held RFID reader.

19. The system of claim 17 wherein the substrate includes an integrated circuit substrate.

20. The system of claim 17 wherein the substrate includes a substrate of a label.

21. The system of claim 17 wherein the microstructure power device includes a MEMS-based device adapted to use electrostatic energy harvesting based on capacitances, between interleaved structures of the MEMS-based device, that are varied in response to the mechanical vibrations.

22. A method, comprising:
affixing an unpowered RFID tag having a microstructure power device coupled thereto to an item;
placing the item having the unpowered RFID tag affixed thereon in an environment where mechanical vibrations are present;
harvesting energy from the mechanical vibrations using the microstructure power device, without using a discrete power source that provides power different from power derived from the harvested energy; and
using the power derived from the harvested energy to power operations associated with the RFID tag.

23. The method of claim 22 wherein using the power derived from the harvested energy includes using said power as auxiliary power in addition to power acquired by the RFID tag from an RF field.

24. The method of claim 22 wherein using the power derived from the harvested energy to power operations includes applying said power for communication of signals using an antenna of the RFID tag, said antenna being adapted primarily for said communication rather than for power acquisition to power the RFID tag.

25. The method of claim 22 wherein harvesting the energy from the mechanical vibrations includes varying separation of interleaved structures of the microstructure power device, in response to the mechanical vibrations, to vary capacitances between the interleaved structures.

26. A system for wirelessly communicating with RFID tags, the system comprising:
means for electrically coupling an RFID tag to a microstructure power device, said RFID tag having the microstructure power device coupled thereto being capable of being affixed to an item that can be placed in an environment where mechanical vibrations are present;
means for harvesting energy from the mechanical vibrations using the microstructure power device, without using a discrete power source that provides power different from power derived from the harvested energy; and
means for using the power derived from the harvested energy to power operations associated with the RFID tag.

27. The system of claim 26, further comprising antenna means coupled to the RFID tag for primarily communicating signals to and from the RFID tag, without further acquiring power for powering said operations associated with the RFID tag.

28. The system of claim 26, further comprising antenna means coupled to the RFID tag both for communicating signals to and from the RFID tag and for acquiring power for powering said operations associated with the RFID tag, said means for using the power derived from the harvested energy using said derived power to supplement said acquired power or as auxiliary power for other operations.

29. The system of claim 26, further comprising:
energy storage means to store at least some of the harvested energy;
charger means for charging the energy storage means with the harvested energy; and
voltage regulator means to deliver the harvested energy from the energy storage means to the RFID tag.

30. The system of claim 26, further comprising automatic data collection means to communicate with the RFID tag, said communications being powered at least in part by the power derived from the harvested energy.
